(19) United States
(12) Patent Application Publication
(10) Pub. No.: US 2012/0205308 A1
(43) Pub. Date: Aug. 16, 2012

(54) PROCESS FOR PURIFYING WASTEWATERS FROM THE WORKUP OF CRUDE AROMATIC NITRO COMPOUNDS

(75) Inventors: Julia Leschinski, Mannheim (DE); Leo Denissen, Brasschaat (BE); Ludwig E. Heck, Edingen-Neckarhausen (DE); Peter Gammer, Nanjing (CN); Bart Van De Voorde, Antwepen (BE); Andreas Heußler, Hassloch (DE); Samuel Neto, Bruxelles (BE)

(73) Assignee: BASF SE, Ludwigshafen (DE)

(21) Appl. No.: 13/207,266

(22) Filed: Aug. 10, 2011

Related U.S. Application Data
(60) Provisional application No. 61/372,881, filed on Aug. 12, 2010.

(51) Int. Cl. C02F 9/10

(52) U.S. Cl. 210/638; 210/639

(57) ABSTRACT

The invention relates to a process for working up wastewaters which are obtained in the purification of crude aromatic nitro compounds after the nitration of aromatic compounds, comprising the following steps:
(a) single-stage or multistage washing of the crude aromatic nitro compound to obtain at least one organic phase and at least one aqueous phase, and removal of the aqueous phase or of the aqueous phases, step (a) comprising the addition of a base other than ammonia, and then
(b) optional removal of organic constituents from at least a portion of the aqueous phase or aqueous phases obtained in step (a) by stripping, preferably with steam, then
(c) removal of organic compounds from at least a portion of the aqueous phase or aqueous phases resulting from step (a) or step (b) by thermal and/or oxidative degradation, then
(d) distillative depletion of ammonia from at least a portion of the aqueous phase or aqueous phases resulting from step (c), and then
(e) optional supply of at least a portion of the aqueous phase resulting from step (d) to a biological wastewater treatment.

### CROSS-REFERENCE TO RELATED APPLICATION

This application claims the benefit of U.S. Provisional Application Ser. No. 61/372,881 filed Aug. 12, 2010, the entire contents of which are incorporated herein by reference in its entirety.

### FIELD OF THE INVENTION

The invention relates to a process for working up wastewaters which are obtained in the purification of crude aromatic nitro compounds after the nitration of aromatic compounds, comprising the following steps:
(a) single-stage or multistage washing of the crude aromatic nitro compound to obtain at least one organic phase and at least one aqueous phase, and removal of the aqueous phase or of the aqueous phases, step (a) comprising the addition of a base other than ammonia, and then
(b) optional removal of organic constituents from at least a portion of the aqueous phase or aqueous phases obtained in step (a) by stripping, preferably with steam, then
(c) removal of organic compounds from at least a portion of the aqueous phase or aqueous phases resulting from step (a) or step (b) by thermal and/or oxidative degradation, then
(d) distillative depletion of ammonia from at least a portion of the aqueous phase or aqueous phases resulting from step (c), and then
(e) optional supply of at least a portion of the aqueous phase or aqueous phases resulting from step (d) to a biological wastewater treatment.

### BACKGROUND

Aromatic nitro compounds, especially mononitrobenzene, are prepared in commercial processes typically by direct nitration of benzene with a mixture of nitric acid and sulfuric acid, known as nitrating acid. This reaction is a biphasic reaction, the reaction rate of which is determined by the mass transfer between the phases and by the chemical kinetics. Of particular industrial significance are continuous processes, and the adiabatic reaction regime has gained particular significance in recent times.

The reaction product (crude product) obtained from the nitration of the aromatic starting compound, especially mononitrobenzene, is initially obtained as a biphasic mixture, the organic phase comprising, as well as the organic nitro compound, further organic by-products and unconverted organic starting materials. In addition to organic constituents, for example mononitrobenzene and benzene, the aqueous phase of course comprises unconsumed nitrating acid. According to the prior art, the acid-containing aqueous phase is typically concentrated in an acid concentrator (sulfuric acid concentration, SAC) and recycled back into the nitrating reaction.

The organic phase obtained from the nitration, referred to hereinafter as crude aromatic nitro compound, is contaminated both with organic secondary components, for example dinitrobenzene, benzene, nitrophenols, and with nitrating acid, and requires a multistage workup which has to meet high demands with regard to energy and process costs, yield and purification of waste streams from an environmental standpoint.

Processes for working up crude aromatic nitro compounds are known from the prior art.

Typically, the removal of the crude aromatic nitro compound (organic phase), especially mononitrobenzene, from the acid-containing aqueous phase is followed by at least one washing step to wash the crude aromatic nitro compound with water or an aqueous solution. A multistage, i.e. sequential, performance of the steps of washing—removal—washing—removal—etc is known from the prior art. Typically, a base is added in at least one washing stage. As a result of addition of bases, the pH after the washing is typically at least 8.

The aqueous phase which results from the aforementioned washing operation (referred to hereinafter as wastewater) comprises, as well as water and salts, also organic compounds such as mononitrobenzene, dinitrobenzene, nitrophenols (mono- and polynitrated phenols) and benzene.

The required depletion of the undesired organic constituents from the wastewater before the introduction thereof into a biological wastewater treatment (water treatment plant) constitutes a significant proportion of the capital costs in the installation of plants for preparation of aromatic nitro compounds.

The organic constituents can be removed from the wastewater, for example, by a one-stage or multistage extraction with benzene. One known process is the one-stage or multistage stripping of the organic constituents with steam, which especially removes low-boiling organic impurities, and subsequent thermolytic or oxidative decomposition of organic constituents still present in the resulting wastewater.

For instance, EP 0 953 546 A2 describes a process for degrading aromatic nitro compounds in wastewaters by heating the wastewater to temperatures of 150 to 350° C. under a pressure of 10 to 300 bar. EP 0 953 546 A2 states that the wastewaters thus treated can be purified biologically without any problem.

EP 1 593 654 A1 describes a process for working up alkaline wastewaters which arise in the washing of crude nitrobenzene, the crude nitrobenzene being prepared by adiabatic nitration of benzene with nitrating acid and then being washed in an acidic wash and then in an alkaline wash to obtain an alkaline wastewater comprising benzene in concentrations of 100 to 3000 ppm and nitrobenzene in concentrations of 1000 to 10 000 ppm, and then benzene and/or nitrobenzene not present in dissolved form being separated out of the alkaline wastewater, and then residual benzene and/or nitrobenzene optionally being removed from the alkaline wastewater by stripping, and the alkaline wastewater subsequently being heated with exclusion of oxygen to temperatures of 150 to 500° C. under elevated pressure.

However, the decomposition of nitro compounds in aqueous wastewaters according to the prior art forms ammonia, which has adverse effects in biological water treatment plants. NH₃-containing wastewater supplied to a biological wastewater treatment first has to be subjected to a nitrification. Nitrification refers to the bacterial oxidation of ammonia (NH₃) to nitrate (NO₃⁻). It consists of two coupled process components: in the first part, ammonia is oxidized to nitrite, which is oxidized in the second process component to nitrate. Nitrification is associated with production of acid (H+ formation); the pH is lowered unless the acid formed is neutralized, for instance by reaction with calcium carbonate (CaCO₃). The acid formed is a burden on the buffer capacity of the water and can acidify the water or the soil. Since nitrifying microorganisms metabolize only in the neutral to slightly alkaline range, the acidification can prevent the complete conversion of the ammonium/ammonia, which is toxic to fish, in wastewater treatment plants (autoinhibition).

The nitrate formed is subsequently subjected, in a further stage of the biological wastewater treatment, to a denitrification to form N₂. Denitrification is understood to mean the conversion of the nitrogen bound within the nitrate (NO₃⁻) to molecular nitrogen (N₂) by particular heterotropic and some autotropic bacteria, which are accordingly referred to as denitrificants.

### BRIEF SUMMARY

It would thus be desirable to provide a wastewater from the abovementioned process which comprises nitrogen in minimum amounts, such that, more particularly, nitrification can be omitted as the first stage of a biological wastewater treatment. This would have great economic and ecological advantages. At the same time, the energy expenditure to obtain the wastewater mentioned should be at a minimum.

It was thus an object of the present invention to provide a process for working up wastewaters for the nitration of aromatic compounds, which has the aforementioned disadvantages to a lesser degree, if at all. More particularly, the ammonia content in the wastewater which is obtained in the nitration of aromatic compounds and subsequent removal of organic constituents should be reduced. It should be possible to very substantially omit the subsequent nitrification in a first stage of a subsequent biological wastewater treatment. At the same time, the process should operate with a minimum level of energy expenditure and be simple to implement industrially.

The aforementioned objects are achieved by the process according to the invention for working up wastewaters which are obtained in the purification of crude aromatic nitro compounds after the nitration of aromatic compounds. Preferred embodiments can be inferred from the claims and the description which follows. Combinations of preferred embodiments do not leave the scope of the present invention, especially with regard to combinations of preferred embodiments of different steps of the process according to the invention.

### BRIEF DESCRIPTION OF THE DRAWING

FIG. 1 is a schematic diagram illustrating a preferred embodiment of the process for working up wastewaters.

### DETAILED DESCRIPTION OF THE PREFERRED EMBODIMENTS

According to the invention, the process comprises the following steps:
(a) single-stage or multistage washing of the crude aromatic nitro compound to obtain at least one organic phase and at least one aqueous phase, and removal of the aqueous phase or of the aqueous phases, step (a) comprising the addition of a base other than ammonia, and then
(b) optional removal of organic constituents from at least a portion of the aqueous phase or aqueous phases obtained in step (a) by stripping, preferably with steam, then
(c) removal of organic compounds from at least a portion of the aqueous phase or aqueous phases resulting from step (a) or step (b) by thermal and/or oxidative degradation, then
(d) distillative depletion of ammonia from at least a portion of the aqueous phase or aqueous phases resulting from step (c), and then
(e) optional supply of at least a portion of the aqueous phase resulting from step (d) to a biological wastewater treatment.

The present process is suitable especially for the workup of wastewaters which form in the purification of crude nitrobenzene which has been obtained by nitration of benzene. For this reason, the process is explained by way of example with reference to this specific purification. However, the person skilled in the art can apply the embodiments mentioned without difficulty to other aromatic starting compounds than benzene, or to other products than mononitrobenzene.

The wastewaters which can be treated by the process according to the invention originate preferably from nitrating plants for nitration of aromatic compounds, for example nitrobenzene plants, dinitrotoluene plants, and nitrotoluene and nitroxylene plants.

The nitration of aromatic starting compounds (especially benzene) to aromatic nitro compounds (especially mononitrobenzene) can be effected by the processes known from the prior art. Suitable processes are described, for example, in EP 043 6 443 A2 and in Kirk-Othmer, Encyclopedia of Chemical Technology, Vol. 17, “Nitrobenzene and Nitrotoluenes”.

Step (a)

The term “washing” in the context of the present invention refers to the contacting an organic phase with an aqueous phase, which transfers at least one constituent of the organic phase at least partly to the aqueous phase. The washing of organic phases and the subsequent or simultaneous removal of the phases is known per se to those skilled in the art and can be effected in apparatuses known per se, such as mixer-separator units (mixing unit followed by separating unit) or extractors, for example extraction columns.

The crude aromatic nitro compound (especially mononitrobenzene) prepared in the aforementioned nitration of the aromatic starting compound (especially benzene) is, in accordance with the invention, first contacted in a one-stage or multistage process with water or an aqueous solution to obtain at least one organic phase and at least one aqueous phase (washing operation). Simultaneously or preferably subsequently, the aqueous phase is removed, or the aqueous phases are removed.

The washing is preferably effected while mixing and/or stirring, such that there is sufficient contact between organic phase and aqueous phase

According to the invention, the washing can be effected in a one-stage or multistage process, preferably by virtue of the crude aromatic nitro compound passing once or more than once in succession through the washing operation with water or an aqueous solution and the separating operation from the aqueous phase. In the latter case, step (a) is passed through more than once in succession. The term “performance of step (a) more than once in succession” is used in the context of the present invention synonymously with the term “multistage performance of step (a)”. If step (a) is performed in a plurality of stages, a single aqueous phase or a plurality of aqueous phases may arise, which comprise different contents of extracted compounds or possibly different compounds.

In a preferred embodiment, step (a) comprises the repeated performance of the washing and separation stages, by contacting a single aqueous phase repeatedly with an organic phase. In this embodiment, only one aqueous phase resulting from stage (a) arises, since it is contacted with the organic phase successively in a plurality of stages and ultimately constitutes the wastewater from step (a).

In a further preferred embodiment, a plurality of, especially two, separate wastewater streams arise, which result from the multistage performance of step (a). It is possible to supply only a portion, especially one of the aqueous phases resulting from step (a), to the steps which follow in accordance with the invention. Alternatively, it is also possible to combine the plurality of aqueous phases mentioned and then to supply them to the steps which follow in accordance with the invention.

The aqueous phase or aqueous phases which result(s) from step (a) are referred to collectively hereinafter as wastewater.

According to the invention, step (a) comprises the addition of a base other than ammonia. Step (a) preferably comprises the addition of an alkali metal carbonate such as sodium carbonate or of an alkali metal hydroxide as the base, particular preference being given to alkali metal hydroxides as the base, especially lithium hydroxide, sodium hydroxide, potassium hydroxide and/or rubidium hydroxide. Sodium hydroxide is most preferred as the base.

The bases mentioned are added especially in the context of at least one wash stage. A wash stage with addition of a base is referred to as alkaline washing. The addition of ammonia as a base in the context of step (a) is undesirable since step (d) which is essential to the invention is then complicated significantly as a result of the enrichment of ammonia.

Preferably that the pH of the wastewater after step (a) is from 7 to 14, preferably 8 to 14, especially 9 to 13. The base is preferably added in the form of aqueous solutions of the base, i.e. at least portions of the aqueous solution used in step (a) comprise the base mentioned. The base, which is preferably added in excess, neutralizes the resulting nitrating acid to form soluble salts.

In one embodiment of step (a), there is an initial acidic wash of the crude aromatic nitro compound. This preferably establishes an acid concentration of 0.5 to 2% by weight of sulfuric acid, based on the aqueous phase. More particularly, an alkaline wash with addition of a base follows immediately. The alkaline wash is preferably effected under the abovementioned conditions.

The wastewater resulting from step (a) typically comprises, as well as water, also residual amounts of benzene and nitrobenzene, and also nitrophenols. The wastewater resulting from step (a) typically comprises benzene in concentrations of 10 to 3000 ppm, preferably of 100 to 1000 ppm, and nitrobenzene in concentrations of 500 to 10 000 ppm, preferably of 1200 to 8000 ppm. The wastewater typically further comprises nitrophenoxides in a concentration of 1000 to 20 000 ppm, especially 2000 to 8000 ppm. The ppm unit in the context of the present invention always refers to parts by weight.

Particular mention is made of the following nitrophenols, which may also be present in the form of their water-soluble salts: mono-, di- and trinitrophenols, mono-, di- and trinitrocresols, mono-, di- and trinitroresorcinols, mono-, di- and trixylenols. Useful salt formers include all metals which are capable of forming water-soluble salts with the nitrophenols. Preference is given to the alkali metals, for example lithium, sodium, potassium and rubidium.

In a preferred embodiment, after step (a) and before performing step (b) or step (c), benzene and/or nitrobenzene which is still present undissolved is removed from the wastewater.

The removal of the undissolved nitrobenzene can be effected by means of separators, settling vessels or other phase separation apparatus. Preference is given to using a settling vessel. The removal mentioned can alternatively be performed in the form of an extraction as described in WO 2009/027416, the content of which is hereby fully incorporated by reference.

The benzene and/or nitrobenzene thus removed is then preferably fed back to the nitrating process or to the crude nitrobenzene.

Step (b)

In a preferred embodiment, in step (b), the removal of organic constituents from at least a portion of the aqueous phase or aqueous phases obtained in step (a) is effected by stripping.

Stripping is understood to mean the removal of particular volatile constituents from the liquids by the passage of gases (air, steam, etc.), the constituents mentioned being transferred to the gas phase or discharged from the liquid with the gas phase.

In the context of the present invention the stripping is preferably performed with steam.

The stripping is preferably effected in a stripping column, in which case the organic constituents, especially benzene and nitrobenzene, are removed overhead. The stripping column is preferably a tubular device with internals for intensive mass transfer of gaseous and liquid phase. The liquid is preferably passed in countercurrent, i.e. passes through the stripping column against the flow direction of the gas. Corresponding processes and columns are known to those skilled in the art and are described, for example, in W. Meier, Sulzer, Kolonnen für Rektifikation and Absorption [Columns for Rectification and Absorption], in: Technische Rundschau Sulzer, 2 (1979), page 49 ff.

Preferred processes are, for example, stripping in a column, which is preferably filled with random beds of random packings, with structured packings or with mass transfer trays, for example sieve trays, bubble-cap trays, tunnel-cap trays or Thormann trays. The stripping in step (b) is preferably performed at an absolute pressure of 0.1 to 10 bar, especially 1 to 5 bar, and a temperature of 35 to 180° C., especially at 100 to 160° C.

The condensate which is obtained in the course of step (b) and comprises the aromatic starting compound and the aromatic nitro compound, and also nonaromatic organic compounds, is subsequently supplied to a phase separator, the organic phase preferably being recycled into the wash in step (a) and the aqueous phase being fed back to step (b). In a preferred embodiment, the steam obtained overhead in the stripping column, including the organic constituents, is used as a heat carrier in step (d), and the condensate obtained is fed to a phase separator, the organic phase preferably being recycled into the wash in step (a) and the aqueous phase preferably being fed back to step (b). This preferred embodiment is explained in detail in the context of step (d).

For safety reasons, error-free function of step (b) is desirable. Malfunction of the stripping column can be monitored, for example, by redundant safety devices.

Preferably, in step (b), an alkaline wastewater is obtained, which comprises benzene only in concentrations of at most 30 ppm, especially at most 5 ppm, and nitrobenzene in concentrations of at most 50 ppm, especially at most 20 ppm.

Step (b) is preferably performed in the presence of defoamers. Suitable defoamers are known to those skilled in the art. Alternatively, mechanical means for defoaming may be provided. Corresponding means are likewise known to those skilled in the art.

Step (c)

In the context of the present invention, in the course of step (c), organic compounds are removed from at least a portion of the aqueous phase or aqueous phases resulting from step (a) or step (b) by thermal and/or oxidative degradation.

The removal of organic compounds from at least a portion of the aqueous phase or aqueous phases resulting from step (a) or step (b) by thermal degradation is referred to hereinafter as thermolysis. Alternatively, the degradation is effected oxidatively, especially by means of ozone (ozonolysis).

Preferably, in step (c), the wastewater which is obtained from steps (a) and (b) and is still laden with organic salts of the nitrohydroxyaromatics is heated with exclusion of oxygen to temperatures of 150 to 500° C., preferably of 250 to 350° C., more preferably 250 to 300° C., under elevated pressure. It is also possible to heat the wastewaters under inert gas atmosphere or under an inert gas supply pressure of, for example, 0.1 to 100 bar. Suitable inert gases are, for example, nitrogen and/or argon. According to the temperature and optional inert gas supply pressure, in the course of heating of the wastewaters, preferably absolute pressures in the range from 50 to 350 bar, more preferably 50 to 200 bar, most preferably 70 to 130 bar, are established. The heating of the alkaline wastewater and decomposition of the organic constituents, such as benzene, nitrobenzene and nitrophenols, is effected typically for 5 to 120 min, preferably 20 to 45 min.

The wastewater is thermalized in pressure vessels at a temperature of 150° C. to 350° C., preferably 250° C. to 300° C., a pressure of 10 bar to 200 bar, preferably 70 bar to 150 bar, and a pH of the wastewater of 8 to 14, preferably 9 to 13.

The pressure vessels used may be all pressure vessels which are known from the prior art and are designed for the abovementioned temperatures and pressures. For a continuous process regime, suitable examples are tubular reactors and autoclaves connected in a cascade.

In a preferred configuration, the wastewater is conveyed with a pump through a heat exchanger in which it is preheated, for example, to 280° C. Subsequently, the preheated wastewater is heated to 300° C. by direct injection of 100 bar steam or by indirect heating. After a residence time of 20 min to 60 min, the reaction solution is cooled in countercurrent with the feed, and decompressed.

For continuous configuration of the process, preference is given to using a tubular reactor in which the flow of the liquid is adjusted such that there is no backmixing.

Preferably, step (c) is performed as thermolysis in the absence of an inert gas at an absolute pressure of 50 to 350 bar and a temperature of 150 to 500° C.

In an alternative embodiment, organic compounds, especially nitrophenols, are removed from at least a portion of the aqueous phase or aqueous phases resulting from step (a) or step (b) by oxidative degradation, preferably by ozonolysis.

Processes for ozonolysis of wastewaters from the nitration of aromatic compounds are likewise known to those skilled in the art. Preference is given to effecting the oxidative degradation by treatment with ozone at 20 to 100° C., a pressure of 1.5 to 10 bar and a pH of 3 to 12. The ozonolysis is preferably performed continuously in a cascade of reactors which are connected in countercurrent. In this way, the ozone is removed so completely from the gas stream that it is usually possible to dispense with a residual ozone destruction. Corresponding processes are described especially in EP 0 378 994 A1, the contents of which are hereby fully incorporated by reference.

After completion of step (c), the content of nitrophenols in the wastewater is preferably at most 100 ppm, especially at most 30 ppm. The content of ammonia in the wastewater which results from step (c) is typically from 100 to 3000 ppm, especially from 500 to 1500 ppm. The nitrate content in the wastewater which results from step (c) is typically from 5 to 500 ppm, especially from 20 to 300 ppm. The nitrite content in the wastewater which results from step (c) is typically from 200 to 10 000 ppm, especially from 500 to 3000 ppm. The content of organically bound nitrogen (calculated in atomic terms) in the wastewater which results from step (c) is typically from 5 to 200 ppm, especially from 5 to 40 ppm.

Step (d)

According to the present invention, step (d) involves the distillative depletion of ammonia from the aqueous phase or aqueous phases resulting from step (c). Ammonia is an undesirable reaction product, though unavoidable at least in traces, from the preceding steps of the process according to the invention, especially step (c). Ammonia can additionally be entrained into the process by use of aqueous phases contaminated with ammonia.

The aqueous phase(s) resulting from step (c) can be distilled by processes known per se.

Preference is given to performing the distillation in step (d) at an absolute pressure of 0.1 to 10 bar, especially 1 to 5 bar, the pressure mentioned being present at the top of the distillation apparatus.

Preference is given to performing the distillative removal of ammonia in step (d) at a temperature of 80 to 140° C., the temperature mentioned being present at the top of the distillation apparatus.

Preferably, the ammonia content in the aqueous phase after step (d) is no more than 100 ppm, especially not more than 20 ppm, more preferably not more than 10 ppm.

The distillative depletion of ammonia from the aqueous phase(s) resulting from step (b) is preferably accomplished at temperatures of 50 to 160° C. and absolute pressures of 0.1 to 10 bar, especially 1 to 5 bar.

The distillative depletion of ammonia can be effected in known apparatus. The evaporation of ammonia is suitably effected in a distillation column. The column may be filled with unstructured packings known to those skilled in the art, for example random beds of random packings, with structured packings or with mass transfer trays, for example sieve trays, bubble-cap trays, tunnel-cap trays or Thormann trays. In a particularly preferred embodiment, unstructured or structured packings and mass transfer trays are combined with one another, so as to achieve an optimal separation effect.

The introduction of heat into the distillation column is preferably effected by an attached evaporator. This allows step (d) to be integrated into the process in an energetically particularly favorable manner.

An evaporator in process technology is an apparatus for converting a liquid to its vaporous state. For evaporation of the liquid, the supply of thermal energy is required. Evaporators therefore generally consist of a surface through which heat from a heat carrier, preferably a liquid, is transferred to the liquid to be evaporated. Preference is given in the context of the present invention to evaporators which transfer the heat required indirectly (no direct contact between heat carrier and liquid to be evaporated). Corresponding evaporators are known per se to those skilled in the art. Suitable evaporators are especially natural circulation evaporators, forced circulation evaporators, kettle evaporators, steam boilers, falling-film evaporators and thin-film evaporators. Particularly suitable evaporators are those based on a tube bundle. Particular preference is given to falling-film evaporators.

In a particularly preferred embodiment, step (d) is coupled for the purposes of heat management to at least one preceding stage, especially stage (b).

The vapor phase resulting from stage (b) is preferably used for indirect heat transfer in stage (d). More preferably, the vapor phase resulting from stage (b) is introduced as a heat carrier into an evaporator in the course of stage (d).

Preferably, the heat carrier, after stage (d), is recycled at least partly into stage (a). In a particularly preferred embodiment, the heat carrier, after stage (d), is subjected to a phase separation to obtain an organic phase and an aqueous phase, the resulting organic phase being recycled into stage (a). The resulting aqueous phase is preferably fed to step (b).

The wastewater which is obtainable by the process according to the invention and has been freed completely or partially of ammonia can be fed directly, i.e. without further separation steps, to a biological wastewater treatment, especially a water treatment plant. The ammonia-comprising top product obtained here is preferably condensed by methods known per se to those skilled in the art, and is preferably partly recycled as a condensate return stream into the distillation column within step (d) and partly sent to a further workup, preferably an incineration. Uncondensed constituents can be supplied to a further offgas treatment.

Step (e)

In the context of step (e) which is conducted with preference, step (d) is followed by the supply of at least a portion of the aqueous phase resulting from step (d) to a biological wastewater treatment stage. At least a portion of the aqueous phase resulting from step (d) is also preferably supplied to a biological wastewater treatment stage immediately after step (d), i.e. without the performance of any further measure for purification of the aqueous phase supplied to the biological wastewater treatment stage and more particularly without the performance of a nitrification.

Corresponding processes for biological wastewater treatment are likewise known per se to those skilled in the art and are described in detail, for example, in Ullmann's Encyclopedia of Industrial Chemistry 7th edition (Chapter Waste Water), 2005 Wiley-VCH Verlag GmbH & Co. KGaA, Weinheim.

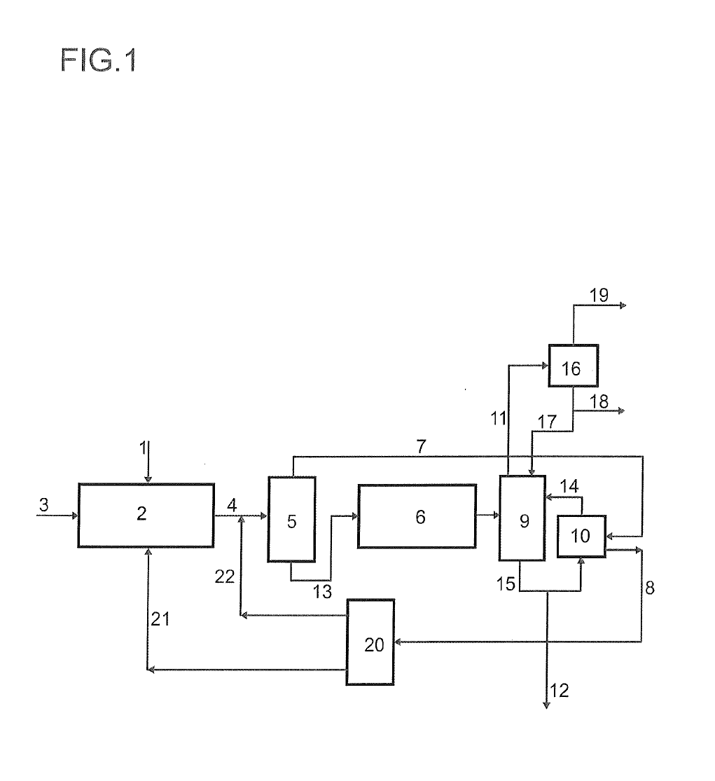

A preferred embodiment of the present invention is shown in FIG. 1.

In FIG. 1, the labels mean:

1—feed of base and water

2—washing and separation unit(s)

3—stream of crude nitrobenzene

4—wastewater stream

5—stripping unit

6—thermolysis unit

7—steam stream from stripping

8—condensate stream from evaporator

9—distillation column (ammonia distillation)

10—evaporator

11—stream to the top condenser of the column

12—stream to biological wastewater treatment

13—bottom product from stripping

14—steam stream from evaporator

15—bottom product from ammonia distillation

16—top condenser of the ammonia distillation

17—condensate return stream to the column

18—top product of the ammonia distillation

19—uncondensable components of the top product

20—phase separator

21—organic phase from phase separator

22—aqueous phase from phase separator

The stream of crude mononitrobenzene (3) from the nitration of benzene is supplied to a washing and separating unit (2). The washing and separating unit (2) consists preferably of a plurality of units in which the stages of washing and subsequent separation of the aqueous phase are performed repeatedly. The washing and separating unit (2) is supplied with a base, especially sodium hydroxide, and water, together or separately (1), and this adjusts the pH of the wastewater stream (4) to 8 to 14, especially 9 to 13. The wastewater stream (4) resulting from the separation of the aqueous phase in the washing and separation unit (2) is fed to a stripping unit (5) in which organic compounds are substantially removed. The bottom product (13) which results from the stripping unit and is the wastewater stream freed substantially of the organic compounds is subsequently fed to a thermolysis unit (6) in which residual organic constituents are substantially decomposed. Subsequently, the wastewater stream is fed to the distillation column (9) for distillative depletion of ammonia. For the purpose of heat integration, the steam stream from the stripping (7) is supplied as a heat carrier stream to an evaporator (10) and used to evaporate portions of the bottom product from the ammonia distillation (15), which is recycled as a steam stream from the evaporator (14) into the distillation column (9) of the ammonia distillation. The stream of the cooled condensate from the evaporator (8) is first fed to a phase separator (20). The resulting organic phase (21) is recycled into the washing and separation unit (2). The resulting aqueous phase (22) is fed to the stripping unit (5). The top product of the distillation column (11) is condensed in a condenser (16), a portion of the condensate (17) of the ammonia distillation (9) being supplied again as a return stream. The condensate (18) not recycled is disposed of, for example by incineration. The uncondensed constituents of the top product (19) are fed to the further offgas cleaning. The bottom product (12) from the ammonia distillation is fed to a biological wastewater treatment.

### EXAMPLES

### Example 1

First, crude mononitrobenzene was obtained according to example 1 from application WO 0164333 (A2) with subsequent phase separation.

The multistage wash of the crude mononitrobenzene thus obtained (step a of the process according to the invention) gave two wastewater streams. The first wash with a mass ratio of water to mononitrobenzene of 0.4 led to a wastewater with 6500 ppm by weight of phenolic secondary components and 3100 ppm by weight of other aromatic components such as benzene and mononitrobenzene. The wastewater from the second wash with a ratio of water to mononitrobenzene of 0.3 comprises a total of 3225 ppm by weight of benzene and mononitrobenzene. The organic secondary constituents of both wastewater streams were removed by stripping with steam (step b of the process according to the invention). The absolute pressure in the stripping was 3.5 bar. The consumption of steam in step b was 8.3 tonnes per hour with a wastewater flow of 58 tonnes per hour supplied to the stripping.

In the top of the column used for the stripping, 7.4 tonnes per hour of a mixture were obtained, which comprised in particular water, benzene, nonaromatic organic constituents and mononitrobenzene. The top product mentioned was supplied to the evaporators of the distillation column for ammonia distillation and condensed therein. After condensation of the top product, the resulting liquid was collected and cooled to 40° C. Subsequently, the liquid was fed to a separator. In the separator, mononitrobenzene, benzene and nonaromatic organic constituents formed an organic phase which was recycled into the wash unit. The aqueous phase from the separator, which was saturated with organic constituents, was recycled to the stripping unit.

At the top of the ammonia distillation column, which was heated exclusively with the top product from step (b) of the process according to the invention, a stream comprising essentially water and ammonia was obtained at a rate of 6.1 tonnes per hour at 1.2 bar absolute. The top product was condensed. 6.0 tonnes per hour of this stream were returned to the column as reflux. The remaining 0.1 tonne per hour, which comprised an ammonia concentration of 20% by weight, was incinerated. At the bottom of the column, 59.3 t/h of water with an ammonia concentration of 10 ppm were obtained.

### Comparative Example 2

Mononitrobenzene was prepared according to example 1 from the application WO 0164333 (A2) with subsequent phase separation.

The multistage wash of the mononitrobenzene thus obtained (step a of the process according to the invention) gave two wastewater streams. The first wash with a mass ratio of water to mononitrobenzene of 0.4 led to a wastewater with 6500 ppm by weight of phenolic secondary components and 3100 ppm by weight of other aromatic components such as benzene and mononitrobenzene. The wastewater from the second wash with a ratio of water to mononitrobenzene of 0.3 comprises a total of 3225 ppm by weight of benzene and mononitrobenzene. The organic secondary constituents of both wastewater streams were removed by stripping with steam (step b of the process according to the invention). The absolute pressure in the stripping was 3 bar. The consumption of steam in step b was 8.3 tonnes per hour with a wastewater flow of 58 tonnes per hour supplied to the stripping.

In the top of the column used for the stripping, 7.4 tonnes per hour of a mixture were obtained, which comprised in particular water, benzene, nonaromatic organic constituents and mononitrobenzene. The top product mentioned was condensed and cooled to 40° C. Subsequently, the liquid was supplied to a separator. In the separator, mononitrobenzene, benzene and nonaromatic organic constituents formed an organic phase which was recycled into the wash unit. The aqueous phase from the separator, which was saturated with organic constituents, was recycled to the stripping unit. At the bottom of the stripping column, 59.4 tonnes of wastewater were obtained per hour with 500 ppm by weight of ammonia.

### Example 3

Mononitrobenzene was prepared according to example 1 from the application WO 0164333 (A2) with subsequent phase separation.

The multistage wash of the mononitrobenzene thus obtained (step a of the process according to the invention) gave two wastewater streams. The first wash with a mass ratio of water to mononitrobenzene of 0.4 led to a wastewater with 6500 ppm by weight of phenolic secondary components and 3100 ppm by weight of other aromatic components such as benzene and mononitrobenzene. The wastewater from the second wash with a ratio of water to mononitrobenzene of 0.3 comprises a total of 3225 ppm by weight of benzene and mononitrobenzene. The organic secondary constituents of both wastewater streams were removed by stripping with steam (step b of the process according to the invention). The absolute pressure in the stripping was 3 bar. The consumption of steam in step b was 8.3 tonnes per hour with a wastewater flow of 58 tonnes per hour supplied to the stripping.

In the top of the column used for the stripping, 7.4 tonnes per hour of a mixture were obtained, which comprised in particular water, benzene, nonaromatic organic constituents and mononitrobenzene. The top product mentioned was condensed and cooled to 40° C. Subsequently, the liquid was supplied to a separator. In the separator, mononitrobenzene, benzene and nonaromatic organic constituents formed an organic phase which was recycled into the wash unit. The aqueous phase from the separator, which was saturated with organic constituents, was recycled to the stripping unit.

At the top of the ammonia distillation column, which was heated with 7.4 tonnes of fresh steam per hour, at 1.2 bar absolute, a stream comprising essentially water and ammonia was obtained at a rate of 6.1 tonnes per hour. The top product was condensed. 6.0 tonnes per hour of this stream were recycled into the column as reflux. The remaining 0.1 tonne per hour, which comprised an ammonia concentration of 20% by weight, was incinerated. At the bottom of the column, 59.3 t/h of water were obtained with an ammonia concentration of 10 ppm.

The inventive examples 1 to 3, compared to comparative example 2, led to a reduction in the ammonia content in the wastewater from 500 ppm to 10 ppm.

In example 1, the consumption of steam was 7.4 tonnes per hour less than in example 3.

The wastewater stream resulting from examples 1 and 3 can be fed directly to biological wastewater treatment, and nitrification can be omitted, in contrast to comparative example 2.

1-16. (canceled)

17. A process for working up wastewaters which are obtained in the purification of crude aromatic nitro compounds after the nitration of aromatic compounds, the process comprising:
(a) single-stage or multistage washing of the crude aromatic nitro compound to obtain at least one organic phase and at least one aqueous phase, and removal of the aqueous phase or of the aqueous phases, step (a) comprising the addition of a base other than ammonia;
(c) removal of organic compounds from at least a portion of the aqueous phase or aqueous phases resulting from step (a) or step (b) by thermal and/or oxidative degradation; and
(d) distillative depletion of ammonia from at least a portion of the aqueous phase or aqueous phases resulting from step (c);

18. The process according to claim 17, wherein step (a) comprises the addition of an alkali metal hydroxide as a base.

19. The process according to claim 17, wherein the wastewaters are obtained in the purification of crude aromatic mononitrobenzene after nitration of benzene.

20. The process according to claim 17, wherein the pH of the aqueous phase after stage (a) is at least 7.

21. The process according to claim 17, further comprising (b) removal of organic constituents from at least a portion of the aqueous phase or aqueous phases obtained in step (a) by stripping, preferably with steam.

22. The process according to claim 21, wherein the vapor phase resulting from stage (b) is used for indirect heat transfer in stage (d).

23. The process according to claim 21, wherein the vapor phase resulting from stage (b) is introduced as a heat carrier into an evaporator in the course of stage (d).

24. The process according to claim 22, wherein the heat carrier after stage (d) is recycled at least partly into stage (a).

25. The process according to claim 22, wherein the heat carrier in condensed form after stage (d) is subjected to a phase separation to obtain an aqueous phase and an organic phase, the organic phase being recycled into stage (a) and the aqueous phase into stage (b).

26. The process according to claim 17, wherein the distillation in step (d) is performed in a distillation column at an absolute pressure of 0.1 to 10 bar, measured at the top of the column.

27. The process according to claim 17, wherein the distillative depletion of ammonia in step (d) is performed in a distillation column at a temperature of 50 to 160° C., measured at the top of the column.

28. The process according to claim 17, wherein the ammonia content in the aqueous phase after step (d) is not more than 100 ppm.

29. The process according to claim 17, wherein step (c) is a thermolytic treatment.

30. The process according to claim 17, wherein step (c) is performed as a thermolytic treatment at an absolute pressure of 50 to 350 bar and a temperature of 150 to 500° C.

31. The process according to claim 17, wherein the aqueous phase or aqueous phases resulting from step (c) is/are supplied completely to step (d).

32. The process according to claim 17, further comprising (e) supply of at least a portion of the aqueous phase resulting from step (d) to a biological wastewater treatment.
